(19) United States
(12) Patent Application Publication
(10) Pub. No.: US 2024/0217645 A1
(43) Pub. Date: Jul. 4, 2024

(54) MAIN BODY OF AN AERIAL VEHICLE

(71) Applicant: Wingcopter GmbH, Weiterstadt (DE)

(72) Inventor: Jonathan HESSELBARTH, Darmstadt (DE)

(73) Assignee: Wingcopter GmbH, Weiterstadt (DE)

(21) Appl. No.: 18/557,117

(22) PCT Filed: Apr. 26, 2022
(86) PCT No.: PCT/EP2022/061071

§ 371 Date: Jan. 25, 2024

(30) Foreign Application Priority Data
Apr. 26, 2021 (DE) 10 2021 110 631.1

(51) Int. Cl. B64C 1/06; B64C 1/00; B64C 5/02; B64F 5/10; B64U 20/65

(52) U.S. Cl. CPC B64C 1/068; B64C 5/02; B64F 5/10; B64C 2001/0072; B64U 20/65

(57) ABSTRACT

A main aircraft body is made of fiber-reinforced composite material. The main aircraft body includes a load-bearing structure configured in the form of an elongate fuselage. Two wings are arranged laterally on the elongate fuselage. The wings are configured such that a lifting force is generated for the aircraft. A plurality of receiving devices for receiving drive means are formed on the wings. The main aircraft body is formed from an upper shell and a lower shell. The upper shell and the lower shell are connected to one another along a common connecting surface. An empennage is arranged at a tail of the fuselage. The empennage is formed by a pair of empennage surfaces. Guide surfaces of the pair of empennage surfaces are oriented in a V-shaped manner in relation to one another in a horizontal direction of flight. The upper shell is produced in one piece.

### CROSS-REFERENCE TO RELATED APPLICATION

This application is a national stage application, filed under 35 U.S.C. § 371, of International Patent Application PCT/EP2022/061071, filed on Apr. 26, 2022, which claims the benefit of German Patent Application DE 10 2021 110 631.1, filed on Apr. 26, 2021.

### BACKGROUND

In the field of aviation, components and structural parts of aircraft are often made of fiber-reinforced composites, wherein this also includes a fiber and plastic composite. In this context, fiber-reinforced composites refer to fibers embedded in a plastic matrix. In the field of aviation, for example, carbon fiber-reinforced plastics (CFRP) are frequently used, wherein carbon fibers are embedded in a plastic matrix. The matrix connects the fibers and fills the spaces between the fibers. Epoxy resin is often used as the matrix material, wherein thermosets or even thermoplastics are also used as the matrix material. Carbon fiber-reinforced plastics are characterized by low mass combined with high stiffness. Glass-fiber reinforced plastics, in which the fibers embedded in a plastic matrix are made of glass fibers, can also be used in the field of aviation.

A component made of carbon fiber-reinforced plastics usually exhibits so-called anisotropic properties, wherein a strength and a stiffness in the fiber direction is significantly higher than across the fiber direction. In order to produce isotropic, i.e. direction-independent, properties, the fiber layers can be oriented and arranged in such a way that they point in several different directions. In addition, the predefined arrangement and orientation of fiber layers allows the desired strength and stiffness to be set in the desired directions and component areas.

In aircraft construction, the so-called prepreg manufacturing process is used to produce components from fiber-reinforced plastics or from a fiber and plastic composite. In this manufacturing process, pre-impregnated fabrics or ready-made textile semi-finished products are soaked in synthetic resins and only thermally treated until they are slightly solidified, so that they can be handled in layers. Such a web-like or layered prepreg semi-finished product usually has a certain adhesion and is therefore easy to place in the corresponding molds or to arrange in layers on top of each other until the desired component shape is formed. Once the desired layers of the prepreg have been arranged, they can be (thermally) cured. To cure these prepreg components, so-called autoclaves are used in which the prepreg components are treated under overpressure of up to 10 bar for several hours at temperatures of 120° C. to 200° ° C., whereby complete curing of the evacuated prepreg components can be achieved.

In aircraft construction or also in the construction of remote-controlled aircraft, such as drones, main aircraft bodies are often produced using different materials and manufacturing processes. In this context, the highly stressed supporting structures, such as the elongated fuselage and the pairs of wings arranged on the elongated fuselage, are frequently manufactured from a carbon fiber-reinforced plastic, wherein the prepreg manufacturing process is used for such large aircraft components. Since the prepreg manufacturing process usually involves lining tool molds with the prepreg semi-finished products, this usually means that only half-shell-shaped parts of a basic aircraft body can be produced. As a rule, a main aircraft body is thus divided into two shell halves—an upper shell and a lower shell. The upper shell and the lower shell are each manufactured individually in their respective tool mold. The cured prepreg components are then shaped into the desired shape by cutting off excess prepreg that protrudes when lining the tool mold, so that the cut prepreg components form the upper shell and the lower shell.

In order to be able to produce a particularly stable connection between the wings and the fuselage, the wings and the upper shell or the lower shell of the fuselage are often already connected in the prepreg manufacturing process by appropriately arranged prepreg semi-finished products to form a prepreg component, so that curing takes place to form a monolithic component.

Empennage components, such as guide surfaces, are also produced using the prepreg manufacturing process. However, depending on the shape and arrangement of the individual aircraft components or tail unit components, it is not possible to produce a monolithic empennage. Rather, the aircraft components or empennage components, which are manufactured separately from each other and individually from fiber-reinforced plastics, must then be assembled to form a main aircraft body or empennage. For this purpose, the empennage components are assembled, for example, with the upper shell of the main aircraft body or the fuselage. In this case, assembly takes place, for example, by means of a joining process such as gluing, riveting or screwing. Joints or joint areas created by such joining processes usually have a lower strength compared to the strength of the aircraft component. Furthermore, such joining areas have a large mass due to a local accumulation of adhesive, rivets or screws to produce the respective joint. By using a large number of joints and joint areas, the total weight of the aircraft increases, which reduces the flight time or range of the aircraft due to the increased power requirements of the drive units caused by the increased mass.

### SUMMARY

The disclosure relates to a main aircraft body of an aircraft made of fiber-reinforced composite material and a method for producing the main aircraft body. The main aircraft body comprises a load-bearing structure configured in the form of an elongate fuselage. A pair of wings consisting of two wings, is arranged laterally on the elongate fuselage. The wings are configured such that, during the course of horizontal flying movement in a horizontal direction of flight parallel to a longitudinal axis of the fuselage, a lifting force is generated for the aircraft, wherein a plurality of receiving devices for receiving drive means are formed on the wings. The main aircraft body is formed from an upper shell and a lower shell. The upper shell and the lower shell are connected to one another along a common connecting surface. An empennage is arranged at a tail of the fuselage. The empennage is formed by a pair of empennage surfaces. Guide surfaces of the pair of empennage surfaces are oriented in a V-shaped manner in relation to one another in a horizontal direction of flight.

It is an object of the present disclosure to provide an aircraft that has a particularly reduced weight and is at the same time stable.

This object is achieved in that the upper shell and/or the lower shell are each produced in one piece. Thus, the number of joints is low, so that a particularly weight-reduced aircraft can be produced. In addition, due to a monolithic upper shell, a particularly high rigidity and strength of the upper shell and the aircraft can be produced. By manufacturing the upper shell and/or the lower shell in one piece, the outer sides of the upper shell and/or the lower shell can be manufactured in such a way that they have an aerodynamic outer surface shape in the horizontal direction of flight.

In order that a particularly large proportion of the main aircraft body can be produced from one piece, it is provided in an advantageous implementation that the guide surfaces are arranged directly on the tail and merge into the tail, such that the empennage is either a component of the upper shell or a component of the lower shell. This means that the empennage, which consists of several different empennage components, can also be manufactured in one piece. Due to the resulting low number of joints, a particularly weight-reduced aircraft can be produced. If the empennage is a part of the upper shell, the surfaces of the V-shaped guide surfaces point upwards. Thus, the empennage can be manufactured in one piece with the upper shell. If the empennage is part of the lower shell, the surfaces of the guide surfaces face downwards, such that the empennage can be manufactured in one piece with the lower shell.

In an advantageous embodiment, the upper shell and the lower shell are made of a fiber and plastic composite in order to produce a basic aircraft body with particularly high strength and low weight at the same time. Advantageously, the upper shell and the lower shell are made of a carbon fiber-reinforced plastic, which falls under the term fiber and plastic composite. Compared to other fiber-reinforced composites, such as glass fiber-reinforced plastics, carbon fiber-reinforced plastics have a particularly low specific weight. Thus, the upper shell and/or lower shell made of the carbon fiber-reinforced plastic can be made to be particularly light, such that a particularly weight-reduced main aircraft body can be produced.

So that a particularly weight-reduced main aircraft body can be produced, in an advantageous embodiment of the main aircraft body it is provided that the upper shell and the lower shell are configured and can be brought into connection with each other along the connecting surface in such a way that an inner volume is enclosed by the upper shell and by the lower shell such that the main aircraft body is configured as a hollow body. Advantageously, the hollow body-like main aircraft body can accommodate the electrical and control equipment necessary for the operation of the aircraft. In addition to GPS receivers, radio transmitters, radio receivers, cameras, batteries or drive motors, electrical cables can also be housed inside the hollow body and protected against environmental influences such as rain, wind and impacts.

The object set out at the outset is achieved by a method for producing a main aircraft body of an aircraft according to claims 1 to 4, wherein the main aircraft body is formed from an upper shell and a lower shell, wherein in a laminating process a shaping of the upper shell and the lower shell is replicated by shaping and arranging one or more layers of a curable material, wherein in a subsequent curing process the one or more layers are cured by adding pressure and temperature, thereby forming the upper shell and the lower shell. Advantageously, the prepreg semi-finished products pre-impregnated with an impregnating resin are used as the curable material, wherein these prepreg semi-finished products have a certain adhesiveness and a certain dimensional stability, so that a shaping of the prepreg component formed from the prepreg semi-finished products can be produced.

In order to be able to reproduce the shaping of the main aircraft body particularly quickly, an advantageous implementation is that the shaping of the upper shell and/or the lower shell is carried out by lining a tool mold with one or more layers of the curable material. By lining the tool mold, the shape of the upper shell and/or the lower shell is advantageously reproducible. In addition, the one or more layers of the curable material can be arranged particularly evenly next to or on top of each other, so that a particularly thin-walled upper shell and/or lower shell can be produced and thus a particularly weight-reduced main aircraft body or aircraft can be produced.

In an advantageous embodiment it is provided that the laminate consists of one or more layers of a prepreg semi-finished product. Thus, during the lamination process, a thickness of the main aircraft body can be defined within different areas of the upper shell and/or the lower shell.

In order to be able to completely and uniformly line all areas of the tool mold, in an advantageous embodiment it is provided that the prepreg semi-finished products have a predetermined blank. With large blanks, large areas of the tool can be lined particularly quickly. Using small blanks, certain areas of the tool mold can be reinforced with one or more layers of the prepreg semi-finished product so that a desired rigidity and/or strength of the main aircraft body can be produced.

In order to produce a desired rigidity and/or strength of the main aircraft body, in an advantageous embodiment of the method, it is provided that the prepreg semi-finished product has different thicknesses within the blank. Furthermore, the prepreg semi-finished products can be prepared in such a way that the lamination process for lining the mold with the prepreg semi-finished products can be carried out particularly quickly, as only one layer of the prepreg semi-finished product needs to be used to achieve the desired rigidity and/or strength of the main aircraft body.

In order to be able to completely line all areas of the tool mold, in an advantageous embodiment, it is provided that for specified areas of the upper shell and the lower shell the tool mold is lined in the laminating process with predetermined blanks of the prepreg semi-finished product suitable for the respective specified areas. This means that in particular curves, bulges or transitions of the tool mold can be lined particularly evenly with the prepreg semi-finished products. Thus, a particularly uniform thickness of the main aircraft body can be produced.

For a particularly uniform curing of the curable material, it is provided in an advantageous embodiment that the curing process is carried out in an autoclave. However, the curing process is also possible and provided for in a conventional oven, whereby little effort is required for preparing the semi-finished prepreg products placed in the tool mold. Furthermore, curing can also be carried out inside heated tool molds. Thus, a particularly fast and uniform curing of the curable material can take place.

For a particularly simple connection of the upper shell and lower shell, it is provided in an advantageous embodiment that the upper shell and the lower shell are joined together in a joining process downstream of the curing process by means of a joining method. Advantageously, the upper shell and the lower shell are joined together by means of gluing, which creates a continuous and even joint surface. Thus, a particularly uniform rigidity and/or strength of the main aircraft body can be produced.

In order to produce a monolithic component particularly easily, in an advantageous implementation, it is provided that the upper shell and the lower shell are joined together in an uncured state in a joining process preceding the curing process. The joining of the upper shell to the lower shell may be accomplished by thermally softening the curable material in the desired joining areas of the upper shell and/or the lower shell, wherein the softened joining areas are brought into contact with each other so that they bond together or at least form some adhesive bond. In the downstream curing process, a solid cured bond is created between the upper shell and the lower shell.

In an advantageous embodiment of the method, it is provided that in the laminating process the one or more layers of the curable material of the upper shell and the lower shell can be brought into contact with each other within an overlap region, such that in the curing process the upper shell and the lower shell combine to form a monolithic main aircraft body. In this case, within the overlap area, an overlap of the one or more layers of the curable material of the upper shell to the one or more layers of the curable material of the lower shell is produced merely by a corresponding arrangement and alignment of the curable material. An upstream or downstream joining process is not necessary. In addition, no joints are necessary for the connection of the upper shell and the lower shell, so that a particularly weight-reduced main aircraft body can be produced.

Further advantageous embodiments of the invention are explained with reference to exemplary embodiments shown in the drawings.

### BRIEF DESCRIPTION OF THE DRAWINGS

FIG. 1 shows a schematic representation of the main aircraft body of the aircraft in a perspective view,

FIG. 2 shows a schematic representation of the main aircraft body consisting of the upper shell and lower shell in a sectional view along sectional line A-A shown in FIG. 1,

FIG. 3 shows a schematic representation of a partial area of the tool mold for the production of the upper shell with prepreg semi-finished products inserted into the tool mold in the area of the empennage of the main aircraft body in a plan view, and

FIG. 4 shows a schematic representation of the tool mold with prepreg semi-finished products inserted into the tool mold for the production of the upper shell in the area of the empennage of the main aircraft body in a sectional view along the sectional line B-B shown in FIG. 3.

### DETAILED DESCRIPTION

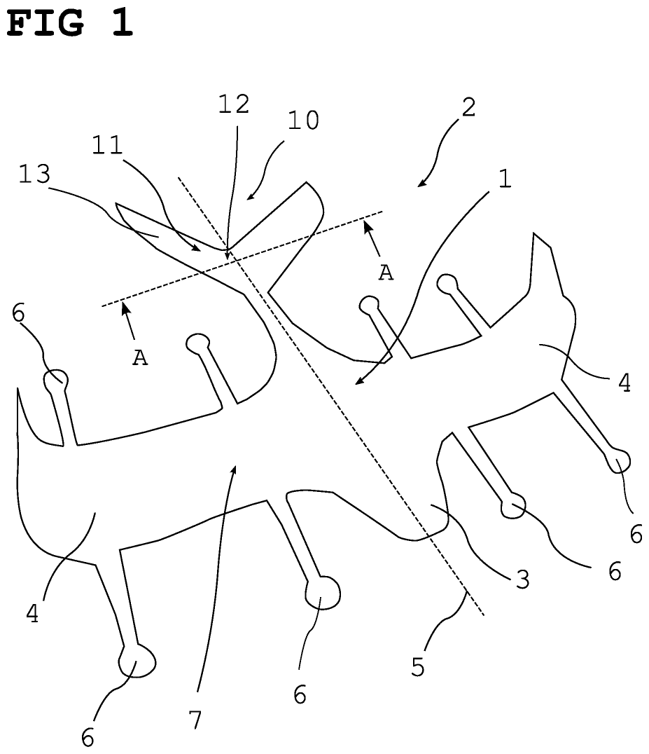

FIG. 1 shows a schematic representation of the main aircraft body 1 of the aircraft 2 in a perspective view. The main aircraft body 1 is made of carbon fiber-reinforced plastic. The main aircraft body 1 has a load-bearing structure configured in the form of an elongate fuselage 3. A pair of wings 4, consisting of two wings, is arranged laterally on the elongate fuselage 3. The wings 4 are configured such that, during the course of horizontal flying movement in a horizontal direction of flight parallel to a longitudinal axis 5 of the fuselage 3, a lifting force is generated for the aircraft 2. A plurality of receiving devices 6 for receiving drive means (not shown in FIG. 1) are formed on the wings 4. The main aircraft body 1 is formed from an upper shell 7 and from a lower shell 8 (not shown in FIG. 1). The upper shell 7 and the lower shell 8 are connected to one another along a common connecting surface 9 (not shown in FIG. 1). At a tail 10 of the fuselage 3, an empennage 11 is formed by a pair of empennage surfaces 12 consisting of guide surfaces 13. The guide surfaces 13 of the pair of guide surfaces 12 are aligned in a V-shape and are part of the upper shell 7.

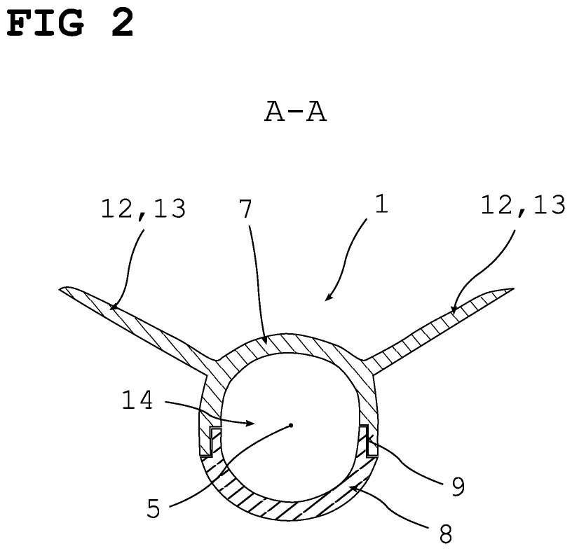

FIG. 2 shows a schematic representation of the main aircraft body 1 consisting of the upper shell 7 and lower shell 8 in a sectional view along sectional line A-A shown in FIG. 1. The upper shell 7 and the lower shell 8 are connected to one another along the common connecting surface 9. Thus, the upper shell 7 and the lower shell 8 are configured and connected with each other along the connecting surface 9 in such a way that an inner volume 14 is enclosed by the upper shell 7 and by the lower shell 8 such that the main aircraft body 1 is configured as a hollow body. The guide surfaces 13 of the pair of guide surfaces 12 are aligned in a V-shape and are part of the upper shell 7. In a joining process, the upper shell 7 and the lower shell 8 are joined together by means of a joining process. Advantageously, the upper shell 7 and the lower shell 8 are joined together by means of gluing, which creates a continuous and even joint surface 9.

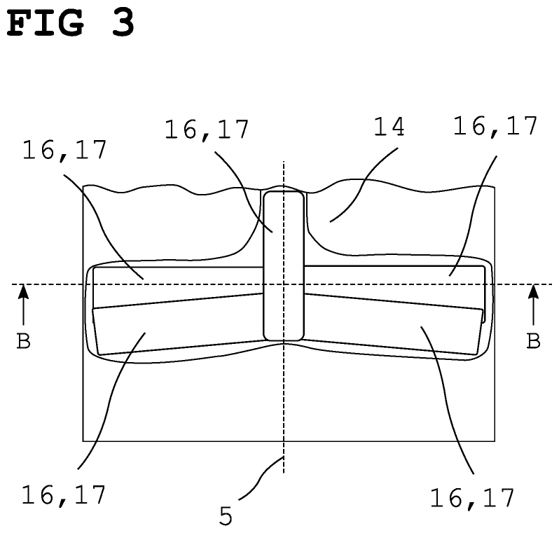

FIG. 3 shows a schematic representation of a partial area of the tool mold 15 for the production of the upper shell 7 with prepreg semi-finished products 16 inserted into the tool mold 15 in the area of the empennage 11 of the main aircraft body 1 in a plan view. By lining the tool mold 15, a shape of the upper shell 7 and/or the lower shell 8 is advantageously reproducible. The one or more layers of prepreg semi-finished products 16 can be arranged particularly evenly next to or on top of each other and can be adapted particularly easily to the tool mold shape. The prepreg semi-finished products 16 consist of several different predefined blanks 17. By using large blanks 17, large areas of the tool mold 15 can be lined particularly quickly and by using small blanks 17, specific areas of the tool mold 15 can be lined particularly precisely.

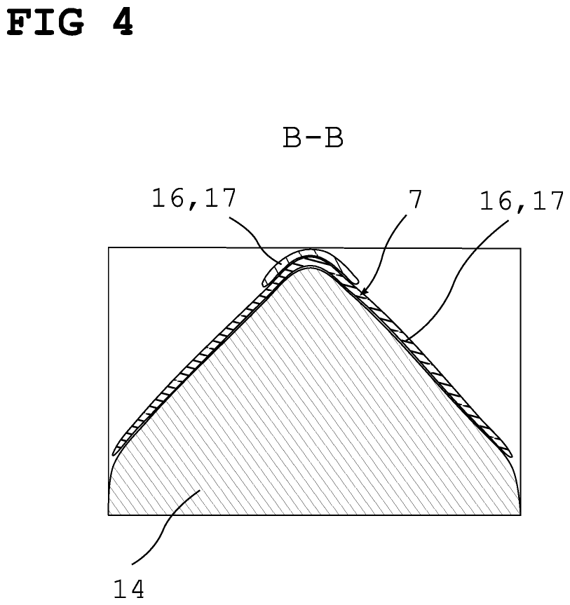

FIG. 4 shows a schematic representation of the tool mold 15 for the production of the upper shell 7 with prepreg semi-finished products 16 inserted into the tool mold 15 in the area of the empennage 11 of the main aircraft body 1 in a sectional view along the sectional line B-B shown in FIG. 3. The shape of the empennage 11 or the guide surfaces 13 is reproduced by lining the tool mold 15. In order to produce a desired rigidity and/or strength of the main aircraft body 1, it is provided that the prepreg semi-finished product 16 has different thicknesses within the blank.

1.-14. (canceled)

15. A main aircraft body (1) of an aircraft made of fiber-reinforced composite material,
wherein the main aircraft body (1) comprises a load-bearing structure configured in form of an elongate fuselage (3),
wherein a pair of wings consisting of two wings is arranged laterally on the elongate fuselage (3),
wherein the wings (4) are configured such that, during horizontal flying movement in a horizontal direction of flight parallel to a longitudinal axis (5) of the elongate fuselage (3), a lifting force is generated for the aircraft (2),
wherein a plurality of receiving devices for receiving drive means are formed on the wings,
wherein the main aircraft body (1) is formed from an upper shell (7) and a lower shell (8),
wherein the upper shell (7) and the lower shell (8) are connected to one another along a common connecting surface (9),
wherein an empennage (11) is arranged at a tail (10) of the elongate fuselage (3),
wherein the empennage (11) is formed by a pair (12) of empennage surfaces,
wherein guide surfaces (13) of the pair of empennage surfaces are oriented in a V-shaped manner in relation to one another in a horizontal direction of flight,
wherein the upper shell (7) and/or the lower shell (8) is produced in one piece.

16. The main aircraft body (1) according to claim 15,
wherein the guide surfaces (13) are arranged directly on the tail (10) and merge into the tail (10), such that the empennage (11) is either a component of the upper shell (7) or a component of the lower shell (8).

17. The main aircraft body (1) according to claim 15,
wherein the upper shell (7) and the lower shell (8) are made of a fiber and plastic composite.

18. The main aircraft body (1) according to claim 15,
wherein the upper shell (7) and the lower shell (8) are configured and can be brought into connection with each other along the common connecting surface (9) in such a way that an inner volume (14) is enclosed by the upper shell (7) and by the lower shell (8) such that the main aircraft body (1) is configured as a hollow body.

19. A method for producing a main aircraft body (1) of an aircraft (2), comprising:
forming the main aircraft body from an upper shell (7) and a lower shell (8);
shaping, in a laminating process, the upper shell (7) and the lower shell (8) by shaping and arranging one or more layers of a curable material;
curing, in a subsequent curing process, the one or more layers by adding pressure and temperature, thereby forming the upper shell (7) and the lower shell (8).

20. The method according to claim 19,
wherein the shaping of the upper shell (7) and/or the lower shell (8) is carried out by lining a tool mold (15) with one or more layers of the curable material.

21. The method according to claim 20,
wherein the upper shell (7) and the lower shell (8) each comprise one or more layers of a prepreg semi-finished product (16).

22. The method according to claim 21,
wherein the prepreg semi-finished products (16) have a predetermined blank (17).

23. The method according to claim 22,
wherein the prepreg semi-finished product (16) has different thicknesses within the blank (17).

24. The method according to claim 22,
wherein for specified areas of the upper shell (7) and the lower shell (8) the tool mold (15) is lined in the laminating process with predetermined blanks (17) of the prepreg semi-finished product (16) suitable for the respective specified areas.

25. The method according to claim 19,
wherein the curing process is carried out in an autoclave.

26. The method according to claim 19,
wherein the upper shell (7) and the lower shell (8) are joined to one another in a joining process downstream of the curing process by a joining method.

27. The method according to claim 19,
wherein the upper shell (7) and the lower shell (8) are joined together in an uncured state in a joining process preceding the curing process.

28. The method according to claim 19,
wherein in the laminating process the one or more layers of the curable material of the upper shell (7) and the lower shell (8) are brought into contact with each other within an overlapping area, such that in the curing process the upper shell (7) and the lower shell (8) combine to form a monolithic main aircraft body (1).
